(19) United States
(12) Patent Application Publication
(10) Pub. No.: US 2019/0137041 A1
(43) Pub. Date: May 9, 2019

(54) METHOD AND DEVICE FOR FILLING A HIGH PRESSURE STORAGE TANK

(71) Applicant: LINDE AKTIENGESELLSCHAFT, München (DE)

(72) Inventors: Wilfried-Henning Reese, Unterschleißheim (DE); Tobias Kederer, Egling-Aufhofen (DE); Martin Brücklmeier, lcking (DE); Simon Schäfer, Pullach (DE); Michael Westermeier, Starnberg (DE)

(73) Assignee: LINDE AKTIENGESELLSCHAFT, München (DE)

(21) Appl. No.: 16/096,079

(22) PCT Filed: Apr. 6, 2017
(86) PCT No.: PCT/EP17/00434

§ 371 Date: Oct. 24, 2018

(30) Foreign Application Priority Data
Apr. 28, 2016 (DE) 102016005220.1

(51) Int. Cl. F17C 13/04; F17C 7/02

(52) U.S. Cl. CPC F17C 13/04; F17C 2270/0139; F17C 2205/0323; F17C 2205/0352; F17C 2221/012; F17C 2223/0161; F17C 2223/035; F17C 2223/036; F17C 2223/046; F17C 2227/0135; F17C 2227/0302; F17C 2227/039; F17C 2250/043; F17C 2250/0439; F17C 2250/0636; F17C 2265/022; F17C 2265/065; F17C 7/02

(57) ABSTRACT

The invention relates to a method for adjusting a hydrogen outlet temperature at a filling station, comprising inter alia a liquid reservoir (1), a cryopump (2), a heat exchanger (6), a gas reservoir (11) and a mixing point (7), wherein a cold hydrogen stream and a warm hydrogen stream are intermixed such that the temperature at the mixing point (7) lies between −30 and −45° C.

The invention pertains to a method for adjusting a hydrogen outlet temperature at a filling station that comprises, among other things, a liquid reservoir, a cryopump, a heat exchanger, a gas reservoir and a mixing point.

An increasing number of vehicle manufacturers offer motor vehicles that run on the gaseous fuels such as natural gas, liquefied petroleum gas or hydrogen. This not only includes passenger cars, but also buses, trucks and forklifts. However, no comprehensive network of filling stations, particularly hydrogen filling stations, has been established as yet.

One reason for the sparsity of hydrogen filling stations or filling stations for vehicles running on hydrogen is their low profitability. Hydrogen filling stations are frequently uneconomical because the number of vehicles running on hydrogen is still very low.

Among other things, a hydrogen filling station comprises a storage tank, in which the hydrogen can be stored in liquid and/or gaseous form. Liquid storage is preferred because the storage density is greater. However, the low temperatures of the liquid hydrogen are disadvantageous in this case. It is also common practice to provide a gas reservoir, in which the hydrogen is stored at an ambient temperature, but compressed to a pressure of up to 1000 bar, particularly up to 910 bar.

Modern hydrogen vehicles are preferably equipped with a fuel tank for storing gaseous hydrogen at a pressure of 350 or 700 bar.

The hydrogen being filled into the fuel tank should have a filling temperature between −33 and −40° C.

This means that the liquid storage of hydrogen, as well as its gaseous storage, requires elaborate devices for conditioning the hydrogen because it either has to be cooled or heated.

A hydrogen filling station therefore typically also comprises at least one pump, particularly a cryopump for liquid storage, multiple heat exchanging devices, multiple pressure control valves, particularly cryogenic high-pressure throttle valves, as well as temperature, pressure and flow controllers. A hydrogen filling station also comprises a fuel dispenser, at which the fuel nozzle and the corresponding filling hose are accessible for the customers. The fuel dispenser typically also comprises electronic devices, particularly for controlling the output and for billing the dispensed hydrogen.

The more components hydrogen filling station requires, the higher the investment costs, as well as any operating and maintenance costs.

The invention is therefore based on the objective of disclosing a method for conditioning hydrogen, in which the filling temperature of the hydrogen at the fuel dispenser can, with observation of a defined pressure variation gradient, maintained at a predefined temperature level without the use of elaborate system technology.

With respect to the method, this objective is attained in that a cold hydrogen stream and a warm hydrogen stream are intermixed in such a way that the temperature at the mixing point lies between −30 and −45° C. The temperature at the mixing point particularly lies between −33 and −40° C.

This is particularly achieved in that a first partial stream, namely a cold hydrogen stream, is fed to the mixing point directly downstream of the cryopump via a gas line. At the mixing point, a temperature sensor preferably measures the temperature of the intermixed gas stream, which is fed from the mixing point to the fuel dispenser via an additional gas line and ultimately dispensed into a receiver tank, particularly the fuel tank of a vehicle or a gas cylinder.

The cold gas stream advantageously has a temperature between −243 and −203° C. or between −203 and −80° C.

Furthermore, a second partial stream is branched off downstream of the cryopump at a manifold. This partial stream is heated by means of a heat exchanger and likewise fed to the mixing point via a gas line.

Downstream of the heat exchanger, the second partial stream is referred to as warm hydrogen stream. The hydrogen is advantageously warmed up in the heat exchanger. In a special embodiment, the heat exchanger may have multiple stages. The warm partial stream advantageously has an ambient temperature, particularly a temperature between −20 and −40° C. The ambient temperature depends on the exterior climatic conditions of the region, in which the filling station is located.

At the mixing point, the proportion of the warm partial stream is advantageously greater than the proportion of the cold partial stream.

Downstream of the cryopump, the hydrogen streams preferably have a pressure between 20 and 1500 bar, particularly between 350 and 1000 bar, especially between 700 and 900 bar.

The pressure of the hydrogen streams, particularly of the warm hydrogen stream, is advantageously adjusted with a pressure controller that is positioned downstream of the gas reservoir.

Downstream of the heat exchanger, the warm hydrogen stream can be selectively or partially fed to the mixing point or stored in a high-pressure reservoir, namely the gas reservoir, via an additional gas line. A pressure controller is arranged downstream of the gas reservoir. The pressure controller is in turn connected to the gas line for feeding the cold hydrogen stream into the heat exchanger.

In this way, the warm gas stream preferably can be directly fed to the mixing point downstream of the heat exchanger. If no warm hydrogen stream or only part of the warm hydrogen stream is currently required at the mixing point, the remainder can be stored in the gas reservoir. When a warm hydrogen stream is once again required, it is withdrawn from the gas reservoir by means of the pressure controller, introduced into the heat exchanger in order to be tempered and subsequently fed to the mixing point.

Hydrogen is advantageously stored in the gas reservoir at a pressure of 500 to 2000 bar, particularly 800 to 1000 bar. If the pressure in the gas reservoir is in an exemplary embodiment higher than in the gas line, the withdrawn hydrogen is expanded by means of the pressure controller. This cools the gas stream such that it is once again tempered by the heat exchanger.

The gas reservoir is preferably realized in the form of a high-pressure gas reservoir that is divided into multiple sections. The individual sections can be advantageously used independently of one another. In a special embodiment, the storage pressures in the individual sections may furthermore differ.

The cryopump of the hydrogen filling station is preferably realized in the form of a reciprocating pump. The quantity of hydrogen being conveyed by the cryopump is advantageously controlled with the frequency of the reciprocating piston. The cryopump particularly makes it possible to precisely deliver the quantity of cold hydrogen required for adjusting the desired temperature at the mixing point.

In a preferred exemplary embodiment, the outlet temperature of the gas stream at the mixing point should lie between −33 and −40° C. and the gas stream should have a pressure of 350 to 900 bar. This gas stream is then dispensed to a vehicle by means of the fuel dispenser, in which pressure, temperature and flow sensors or controllers are advantageously installed.

The temperature can be optimally adjusted due to the fact that a warm gas stream and a cold gas stream are intermixed at the mixing point. Only one heat exchanger, which can also have smaller dimensions, is required because only one partial stream is advantageously heated. The investment and operating costs are thereby reduced.

If a heat exchanger for the cold gas stream is required in a special embodiment, this heat exchanger may likewise have smaller dimensions. In addition, the heat exchangers can be operated independently of one another and thereby respectively adapted to the operation or capacity utilization of the filling station.

The pressure controller makes it possible to ensure that the warm gas stream is on the same pressure level as the cold gas stream, which is directly compressed by the cryopump, and that the two gas streams can be intermixed at the mixing point in the correct ratio for achieving the desired temperature level. To this end, the temperature sensor is advantageously connected to the drive of the cryopump. It is advantageous that no additional valves and controllers for adjusting the temperature are any longer required at the mixing point and in the gas line between the distribution point downstream of the cryopump and the cryopump.

The hydrogen is advantageously stored in a storage tank of the filling station in liquid form. In addition, the storage tank preferably is directly connected to the cryopump.

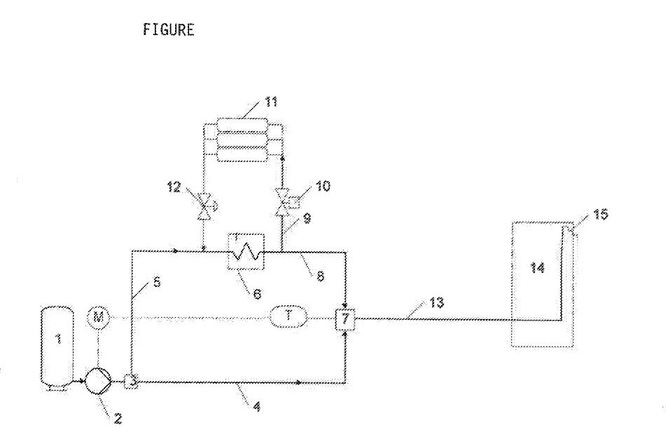

The invention is described in greater detail below with reference to an exemplary embodiment that is schematically illustrated in FIG. 1.

FIG. 1 shows a preferred embodiment of the inventive method. Hydrogen is stored in liquid form in a liquid reservoir 1. The liquid hydrogen is withdrawn from the liquid reservoir 1 by means of a cryopump 2 and only conveyed or also compressed depending on the respective requirements. The gas stream from the cryopump 2 is divided into a gas line 4 and/or a gas line 5 in a manifold 3. The gas line 4 directly feeds the gas stream from the cryopump 2 to the mixing point 7. The gas stream exiting the cryopump 2 has a temperature between −223 and −210° C. and a pressure of 900 bar. The gas line 5 leads to the mixing point 7 via a heat exchanger 6 and a gas line 8. Starting from the gas line 5, the gas line 9 branches off the gas line 8 downstream of the heat exchanger. The gas line 9 leads to the gas reservoir 11 via a shut-off valve 10. The gas reservoir 11 is a high-pressure reservoir, which is divided into multiple storage containers that can be separated from one another. The hydrogen gas heated by means of the heat exchanger 6 is stored in the gas reservoir 11 at a pressure of 500 to 1000 bar and a temperature of −20 to 40° C. The gas can be once again fed into the gas line 5 by means of the pressure controller 12 and likewise fed to the mixing point 7 via the heat exchanger 6 and the gas line 8. The temperature at the mixing point 7 is measured with a temperature sensor T. The temperature sensor T is connected to the drive unit M of the cryopump 2 via a data link. The temperature measured at the mixing point 7 specifies the temperature, at which the hydrogen is dispensed into the storage tank of the vehicle. This temperature must lie between −33 and −40° C. In order to adjust this temperature, a cold stream, which originates directly from the cryopump and is delivered via the gas line 4, is mixed with the warmer stream from the gas line 8 at the mixing point. A gas line 13 leads from the mixing point 7 into the fuel dispenser 14 and the filling hose 15, by means of which the storage tank of the vehicle is filled with hydrogen.

### LIST OF REFERENCE SYMBOLS

1 Liquid reservoir
2 Cryopump
3 Manifold
4 Gas line
5 Gas line
6 Heat exchanger
7 Mixing point
8 Gas line
9 Gas line
10 Shut-off valve
11 Gas reservoir
12 Pressure controller
13 Gas line
14 Fuel dispenser
15 Filling hose

1. A method for adjusting a hydrogen outlet temperature at a filling station that comprises a liquid reservoir, a cryopump, a heat exchanger, a gas reservoir and a mixing point, characterized in that a cold hydrogen stream and a warm hydrogen stream are mixed in such a way that the temperature at the mixing point lies between −30 and −45° C.

2. The method according to claim 1, characterized in that the temperature at the mixing point lies between −33 and −40° C.

3. The method according to claim 1, characterized in that the cold gas stream has a temperature between −243 and −203° C.

4. The method according to claim 1, characterized in that the warm gas stream has an ambient temperature.

5. The method according to claim 1, characterized in that the hydrogen streams have a pressure between 20 and 1500 bar downstream of the cryopump.

6. The method according to claim 5, characterized in that the pressure of the hydrogen streams is adjusted with a pressure controller that is positioned downstream of the gas reservoir.

7. The method according to claim 1, characterized in that hydrogen is stored in the gas reservoir at a pressure of 500 to 2000 bar.

8. The method according to claim 1, characterized in that the quantity of hydrogen being conveyed by the cryopump is controlled with the frequency of the reciprocating piston.

9. The method according to claim 1, characterized in that the hydrogen is warmed up in a heat exchanger.

10. The method according to claim 3, characterized in that the cold gas stream has a temperature between −203° and −80° C.

11. The method according to claim 4, characterized in that the warm gas stream has a temperature between −20° and +40° C.

12. The method according to claim 5, characterized in that the hydrogen streams have a pressure between 350 and 1000 bar.

13. The method according to claim 12, characterized in that the hydrogen streams have a pressure between 700 and 900 bar.

14. The method according to claim 6, characterized in that the hydrogen streams is the warm hydrogen stream.

15. The method according to claim 7, characterized in that hydrogen is stored in the gas reservoir at a pressure of 800 to 1000 bar.
